(19) United States
(12) Patent Application Publication
(10) Pub. No.: US 2004/0190500 A1
(43) Pub. Date: Sep. 30, 2004

(54) Method for maintaining quality of service for telephone calls routed between circuit switched and packet switched networks

(75) Inventor: John D. Wratten, Winchester (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Westell Technologies, Inc.

(21) Appl. No.: 10/780,011

(22) Filed: Feb. 17, 2004

Related U.S. Application Data
(60) Provisional application No. 60/450,743, filed on Feb. 28, 2003.

(51) Int. Cl. H04L 12/56

(52) U.S. Cl. 370/352; 370/395.2

(57) ABSTRACT

A call path for a call between devices may include one or more transitions between circuit switched networks and packet switched networks. Elements in the call path may communicate with each other in order to determine whether the call may be rerouted to bypass one or more circuit switched network segments in the call path, thereby potentially reducing the number of transitions between the circuit switched networks and the packet switched networks in the call path.

### RELATED APPLICATION

This application claims priority to U.S. Provisional Patent Application 60/450,743, filed Feb. 28, 2003, which is hereby incorporated by reference in its entirety.

### FIELD OF THE INVENTION

This application relates generally to routing telephone calls. More specifically, it relates to routing telephone calls between circuit switched and packet switched networks.

### BACKGROUND OF THE INVENTION

Telephone calls have traditionally been routed over circuit switched networks; however, many techniques are now available for transmitting telephone calls over packet switched networks. Oftentimes a single call is routed over multiple different types of networks. For example, a single call may be routed over one or more circuit switched networks and also over one or more packet switched networks. Thus, a single call may be routed such that a call path for the call has multiple transitions between circuit switched networks and packet switched networks.

The circuit switched networks and packet switched networks commonly use different methods for carrying the call over their respective links. For example, many circuit switched digital telephony systems use an 8 KHz pulse code modulated signal to carry calls, but other analog signaling methods may be used as well. Many packet switched digital telephony systems use the Internet Protocol (“IP”) Real Time Protocol (“RTP”) to carry calls, but other packet-based protocols may also be used. Thus, in a circuit switched network the call is typically carried as an analog signal, while in a packet switched network the call is typically both digitized and packetized.

At the boundaries of these networks, the audio component of the call may be translated between the particular analog signaling method used on the circuit switched network and the protocol that is used on the packet switched network. At the boundary from a circuit switched network to a packet switched network, the call is typically encoded from an analog signal into a digital signal, which may then be packetized for transmission over the packet switched network. While many methods exist for encoding the analog signal into a digital format, these methods may result in some form of degradation of the perceived quality of reproduction when the signal is decoded back into an analog form.

As previously described, a call path may include multiple transitions between circuit switched networks and packet switched networks. At each of the transitions from a circuit switched network to a packet switched network the signal may undergo encoding from an analog format to a digital format. Each transition from an analog form into a digital form may introduce its own degradation to the signal quality. Further, degradations introduced by one transition from analog to digital form may be amplified as the signal propagates through the call path and undergoes subsequent transitions from analog to digital form.

Therefore, there exists a need for an improved method for maintaining quality of service for telephone calls routed between circuit switched and packet switched networks.

### BRIEF DESCRIPTION OF THE DRAWINGS

Exemplary embodiments of the present invention are described herein with reference to the drawings, in which:

FIG. 1 is a block diagram illustrating an exemplary call path that includes multiple transitions between a circuit switched network and a packet switched network;

FIG. 2 is a block diagram of an exemplary rerouting of the call path of FIG. 1 in order to reduce transitions between the circuit switched and packet switched networks;

FIG. 3 is a flowchart of an exemplary process for maintaining quality of service for calls routed between a circuit switched network and a packet switched network;

FIG. 4 is a flowchart of an exemplary process an egress gateway can use to handle a gateway indication message; and

FIG. 5 is a flowchart of an exemplary process an ingress gateway can use to handle a gateway indication message.

### DETAILED DESCRIPTION OF EXEMPLARY EMBODIMENTS

1 Call Path Overview

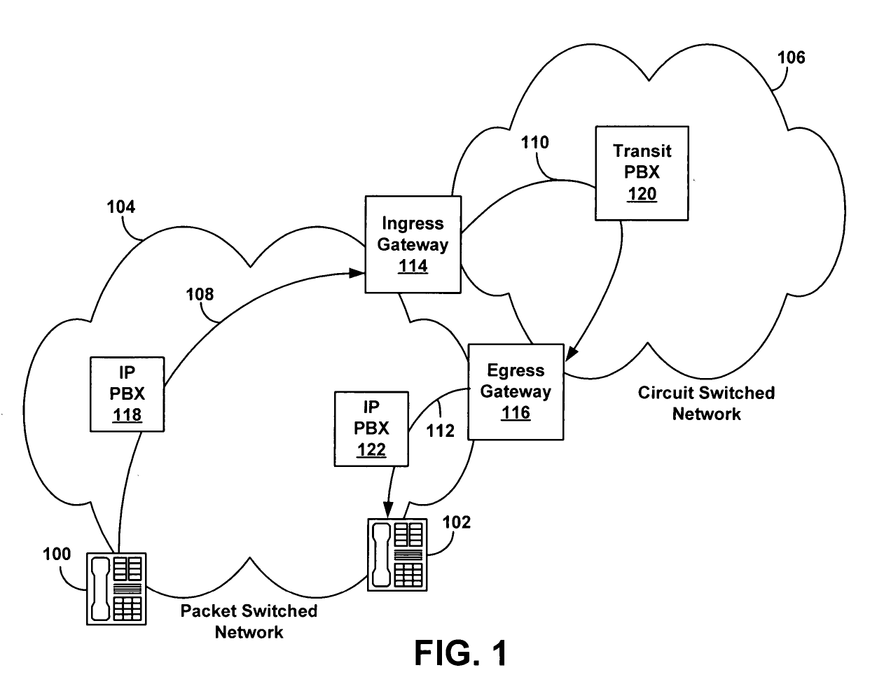

FIG. 1 is a block diagram illustrating an exemplary call path that includes multiple transitions between a circuit switched network and a packet switched network. As illustrated in FIG. 1, a first telephone 100 places a call to a second telephone 102, thereby prompting a call path to be established between the first and second telephones 100, 102. Once established, the call path can be used to transmit voice, data or other traffic between the telephones 100, 102. It should be understood, however, that the first and second telephones 100, 102 are merely exemplary in nature. For example, computers, fax machines or many other types of devices might also be used.

As shown in FIG. 1, the call path between the first telephone 100 and the second telephone 102 traverses a packet switched network 104 and a circuit switched network 106. The packet switched network 104 may be any type of packet network, such as an Internet Protocol (“IP”) network. IP may be used in conjunction with other lower level and higher level protocols in order to carry packetized data over the packet switched network 104. It is not necessary, however, that the packet switched network 104 be an IP network, and any other type of packet switched network may be used.

The call path depicted in FIG. 1 includes three segments: a first packet switched network segment 108, a circuit switched network segment 110, and a second packet switched network segment 112. The first packet switched segment 108 generally runs over the packet switched network 104 and carries the call between the first telephone 100 and an ingress gateway 114. The ingress gateway 114 provides an interface between the packet switched network 104 and the circuit switched network 106. The circuit switched network segment 110 generally runs over the circuit switched network 106, and it carries the call between the ingress gateway 114 and an egress gateway 116. The egress gateway 116 provides an interface between the circuit switched network 106 and the packet switched network 104. The second packet switched network segment 112 then carries the call between the egress gateway 116 and the second telephone 102.

Although FIG. 1 depicts only two networks 104, 106, alternate call paths may traverse a greater number of networks. For example, a particular call path might traverse more than one packet switched network, and it may traverse more than one circuit switched network. Also, while FIG. 1 depicts the first and second telephones 100, 102 as both residing on the packet switched network 104, they might alternatively reside on different networks, such as a circuit switched network or different packet switched networks. Various other differences might also exist between other call paths and the exemplary call path depicted in FIG. 1.

A call path may include post branch exchanges (“PBXs”) or other components that aid in establishing and processing the call. These components may be stand-alone components, or their functionality may be integrated into other components. As shown in FIG. 1, the first packet switched network segment 108 is routed through an IP PBX 118 on the packet switched network 104. The circuit switched network segment 110 is routed through a transit PBX 120, and the second packet switched segment 112 is routed through an IP PBX 122. The particular protocols supported by the PBXs 118, 120, 122 can vary depending on the protocols used by their respective networks. For example, if the packet switched network 104 is not an IP network, then the IP PBXs 118, 120 might alternatively not be IP PBXs but rather support one or more other protocols. Also, the PBXs 118, 120, 122 are merely exemplary in nature, and the call path may optionally include components in addition to the PBXs 118, 120, 122 or in place of the PBXs 118, 120, 122.

2. Altering the Call Path Overview

A call path between devices may include multiple transitions between packet switched networks and circuit switched networks. Thus, when a calling party initiates a call to a called party, the established signaling path from the calling party to the called party may include one or more transitions between the circuit switched and packet switched networks. Subsequent services, such as call forwarding, diversion, redirection or others, may alter the established call path to introduce additional transitions between the circuit switched networks and packet switched networks. Alternatively, these services may introduce transitions at the time the call path is established.

The exemplary call path between the first and second telephones 100, 102 in FIG. 1 includes two transitions between the packet switched network 104 and the circuit switched network 106. The first transition occurs when the first packet switched segment 108 transitions through the ingress gateway 114 to the circuit switched segment 110. The second transition occurs when the circuit switched segment 110 transitions through the egress gateway 116 to the second packet switched segment 112. Thus, one of the transitions is from the packet switched network 104 into the circuit switched network 106, and the other transition is from the circuit switched network 106 back into the packet switched network 104.

As previously described, the transitions between the packet switched network 104 and the circuit switched network 106 can introduce a loss of quality in the signal. For example, when the call signal transitions from the circuit switched network 106 to the packet switched network 104, the call signal may be converted from an analog form to a digital form. This conversion generally causes a loss in the quality of the signal when it is subsequently reproduced. Repeated transitions of this type can further degrade the quality of the call signal.

In order to preserved the quality of the call signal, the call path between the calling and called party may be rerouted so as to remove one or more of the transitions between circuit switched and packet switched networks. For example, where the call path transitions from a circuit switched network to a packet switched network and then back to the packet switched network, the call path may be rerouted so as to remove the excursion into the circuit switched network. This may be done, for example, during the original routing of the call, or it may alternatively be performed after the call has already been routed. Reducing the number of these transitions, such as by bypassing one or more circuit switched segments in the call path, may aid in maintaining the quality of the call as it travels through the call path and is then reproduced at one end. In one embodiment, the bearer path may be rerouted while the signaling path remains the same; however, in other embodiments, the signaling path may be modified as well.

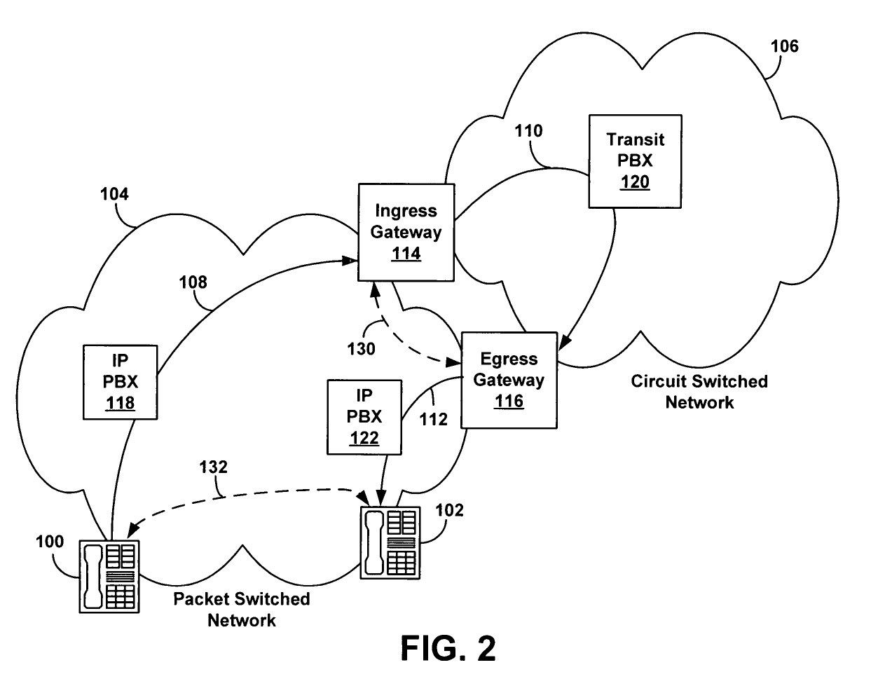

FIG. 2 is a block diagram of an exemplary rerouting of the call path of FIG. 1 in order to reduce transitions between the circuit switched and packet switched networks. In order to reduce the transitions, signaling elements in the call path may communicate with each other in order to identify one or more call segments in call path that may potentially be bypassed in order to reduce the number of transitions between networks. Once the particular segments are identified, they may be removed from the call path, thereby potentially creating a call path with fewer transitions between different types of networks.

In this example, the egress gateway 116 and the ingress gateway 114 may communicate via an inter-gateway connection 130. The inter-gateway connection 130 generally illustrates a conceptual flow of information between the gateways 114, 116 and does not necessarily represent a direct physical connection between the gateways 114, 116. The information exchanged between the gateways 114, 116 may travel over a variety of different paths, such as through the packet switched network 104 or through the circuit switched network 106.

In one embodiment, the egress gateway 116 may send signals through the backward signaling path for the call, and the signaling may be associated with specific existing messages within the call procedures rather than requiring a new message flow. The signals would therefore travel from the egress gateway 116 through the circuit switched network 106 to the ingress gateway 114. The signaling may include information that allows the ingress gateway 114 to then communicate with the egress gateway 116 in order to redirect the bearer path for the call to bypass the circuit switched network 106, thereby eliminated the circuit switched segment 110.

As depicted in FIG. 2, the ingress gateway 114 and the egress gateway 116 communicate via the inter-gateway connection 130 in order to identify an alternate path for bearer traffic. As the telephones 100, 102 both reside on the packet switched network 104, they could communicate with each other directly via the packet switched network 104 without having to go through the circuit switched network 106. Thus, as a result of the negotiation, the bearer path is rerouted so that the telephones 100, 102 communicate with each other over a circuit switched network bypass segment 132, which connects the devices via the packet switched network 104 without the previous excursion to the circuited switched network 106.

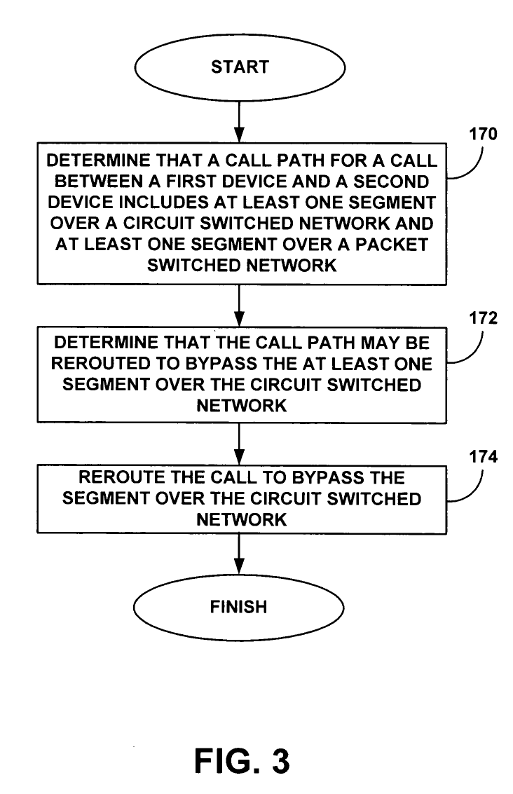

FIG. 3 is a flowchart of an exemplary process for maintaining quality of service for calls routed between a circuit switched network and a packet switched network. At Step 170, the network determines that a call path for a call between a first device and a second device includes at least one segment over a circuit switched network and at least one segment over a packet switched network. At Step 172, the network determines that the call path may be rerouted to bypass the at least one segment over the circuit switched network. Then, at Step 174, the network reroutes the call to bypass the segment over the circuit switched network.

As part of determining that the call path may be rerouted to bypass the at least one segment over the circuit switched network, a first element located at a transition from the circuit switched network to the packet switched network may send a message through a backward signaling channel for the call path, and the message may indicate that the call path transitions from the circuit switched network to the packet switched network at the first element. A send element located at a transition from the packet switched network into the circuit switched network may receive the message. In response, the first and second elements may thereafter negotiate to determine an alternate call path that bypasses the at least one segment over the circuit switched network.

The following sections describe in more detail exemplary processes for establishing a call path and then rerouting the call path in order to reduce transitions between networks.

3. Establishing the Call Path

The call path for the call may be established using any number of call signaling methods. The signals used to establish the call path may travel over one or more networks connecting a calling party with a called party, and the signals may travel between various elements on these networks. For example, whether manually dialed or made by automatic equipment, a call path for a call may be established by sending a number of signals between a PBX or other equipment acting as an agent for the calling party and equipment acting as an agent for the called party. The signaling can be used to determine a path between the parties, to determine the availability of the called party and to establish the call between the parties.

In this example, as FIG. 1 depicts a call from the first telephone 100 to the second telephone 102, the calling party would be the first telephone 100 and the called party would be the second telephone 102. These labels are merely arbitrary, however, and may change based on the particular device initiating the call. Also, in this example, the IP PBX 118 acts as an agent for the first telephone 100, and the IP PBX 122 acts as an agent for the second telephone 102. These too are also merely exemplary in nature, and as previously described, many other types of components might serve as agents for one or both of the parties.

Although many methods exist for establishing a call, in one exemplary embodiment, initial call setup signals may originate from the calling party and indicate a phone number or other identifier of the called party. These call setup signals may be interpreted by the calling party's agent and then by successive call switching devices in the network to achieve a signaling path or route through the network to the agent serving the called party. Once the route is established, the agent for the called party may indicate to the called party that a call has arrived and the two agents can then create a path or route for voice or data traffic, sometimes termed the bearer path. Switching points in the network between the calling party and the called party may sometimes be termed transit nodes. In a circuit switched network, the bearer path commonly passes through the same transit nodes as the signaling path; however, this is not necessarily always the case for circuit switched networks nor is it always necessarily the case for packet switched networks.

The agent for the called party may return a ringing indication to tell the calling party that the called party's telephone is ringing. The agent for the called party may further return a connection indication when the called party's telephone is picked up. In a digital network these signals and indications may be passed in messages. Forward messages generally include those messages from the calling party's agent to the called party's agent, while backward messages generally include those messages from the called party's agent to the calling party's agent. It should be understood, however, that the directional labels for these messages are arbitrary.

If the called party is busy or cannot be contacted, their agent may indicate this to the calling party's agent. The called party's agent may also provide further information, such as an alternate telephone number or other identifier for the called party. The calling party's agent may then immediately direct the call to another number, such as can be done with diversion or redirection services. Under some circumstances, such as call forwarding, the called party's agent may itself place the call to the alternative number so that the calling party's agent is not actively involved. The called party may optionally place a call to a third party and then transfer the calling party.

4. Detecting Unwanted Segments in the Call Path

At various points in the progress of a call, each gateway that has routed the call to a packet based network (e.g., the egress gateway 116), preferably includes within backward messages an indication that the call has entered the packet based network 104. This indication can be included within the permitted signaling elements that may be passed in the appropriate backward call control signal messages back through the circuit switched network 106. As signaling arrives at successive transit elements along the path back to the call originator, the signals can be examined to determine whether any information is of relevance to the element.

If the transit node is an ingress gateway 114 for the call, the ingress gateway 114 preferably passes the gateway indication on in its signaling and preferably also attempts to establish a connection, such as an IP connection, to the egress gateway 116. The ingress and egress gateways 114, 116 can then exchange information via the connection. The information exchange between the gateways 114, 116 can be used to determine whether they can form a connection, such as an IP connection, directly between the remote end-points of the two sections to which they are connected. If this is possible, then the calling party's bearer path may be arranged to bypass the circuit switched segment 110 between the ingress and egress gateways 114, 116.

A proprietary gateway discovery protocol may be used to establish a connection between the ingress and egress gateways 114, 116. However, it should be understood that proprietary protocols other than the ones described herein may be used to establish the connection between the ingress and egress gateways 114, 116. Still alternatively, one or more standardized protocols for communication between gateways might be used. Also, a gateway that becomes an egress and ingress gateway for the same call might be able to internally determine that a segment could be bypassed without even using the gateway discovery protocol, but the gateway would preferably still be able to respond to discovery signaling from other gateways.

5. Gateway Indication Message

A gateway indication message (“GIM”) may be used by gateways or other elements in the call path in order to communicate with each other to identify potential segments in the call path to bypass. The gateway indication message passed between the gateways or other elements in the call path can take the form of a signaling element embedded within normal call control signaling. The particular implementation of the gateway indication message may be standardized within the various protocols that are used. Alternatively, protocols such as Q-Signaling protocol (“QSIG”) or digital private network signaling system (“DPNSS”) permit manufacturer specific extensions that can be used to implement the gateway indication message. A variety of different protocols may be used to implement the gateway indication message, and the particular implementation of the gateway indication message may vary depending on the particular protocol that is used.

For instance, in the Q-Signaling protocol (“QSIG”), the gateway indication message might be implemented using a Remote Operations or Additional Network Feature Invoke operation inside a facility information element. In a digital private network signaling system (“DPNSS”), the gateway indication message might be implemented using a Service-Independent string. In H.323 the gateway indication message might be implemented using an H.225.0 facility element or an H.450 element. In the media gateway control protocol (“MGCP”), the gateway indication message might be implemented directly in the call control signaling section of the gateway controller such that no MGCP extension would be necessary. These are merely examples. Many other methods might be used to implement the gateway indication message, and these methods are not limited to the previously described protocols. Other protocols may be used as well.

Table 1 illustrates exemplary fields that may be included in a gateway indication message. It should be understood, however, that these fields for the gateway indication message are merely exemplary in nature. Other fields may also be used, and the gateway indication message may include a greater or fewer number of fields. Also, it should be understood that the ranges are merely exemplary in nature, and other implementations of the gateway indication message may use different ranges.

TABLE 1
Exemplary Gateway Indication Message Fields

| Field | Type | Range | Description |
|---|---|---|---|
| 1 Call reference | Number | 1 . . . 65535 | The Call Reference may be set by the gateway that |
| | | | generates or re-generates the indication signal. It |
| | | | may uniquely identify the call in such a way that |
| | | | that gateway can use the reference value to identify |
| | | | subsequent signaling relating to that call. |
| 2 Hop Count | Number | 1 . . . 25 | The Hop Count can be a number of segments |
| | | | encountered by a GIM on the backward route to the |
| | | | call originator. The Hop Count may be set to 1 by |
| | | | the gateway that inserts the GIM, and it may be |
| | | | incremented at each successive gateway that |
| | | | regenerates the GIM. |
| 3 Service type | Number | 1 | [CHOICE] 1 = Loop Avoidance Service |
| 4 Address Data | Sequence | | The Address Data may identify a route to the last |
| | | | gateway that generated or regenerated the GIM. |
| 4.1 IP address | xxx.xxx.xxx | Any legal | OPTIONAL, at least 1 of 4.1, 4.2 is preferably |
| | .xxx[port] | | present |
| 4.2 Name | String | Up to 25 | OPTIONAL, at least 1 of 4.1, 4.2 is preferably |
| | | IA5 chars | present |

The gateway indication message may include a call reference. The call reference may be a reference used to identify the call. The call reference may be, for example, an index to a table of routed calls. Alternatively, some other mechanism may be used to identify calls.

The gateway indication message may also include a hop count. The hop count may be a count of the number of packet switched segments encountered on the backwards route to the calling party. For example, the hop count might be set by the gateway generating the gateway indication and then incremented at each successive egress gateway.

The gateway indication message may also include a service type identifier. The service type identifier may identify a service type being exported by the gateway. For this example, which only uses the gateway indication messages to implement loop avoidance, this field would generally always be set to 1 or to some other predetermined identifier. If the gateway indication message is used to implement other services, then this field might be changed according to which services the particular gateway indication message is used for.

The gateway indication message may also include address data. The address data may be a sequence of optional fields, such as a name field, a uniform resource locator field, an IP address field or other fields. That address data preferably includes sufficient information to identify the egress gateway and a route by which the egress gateway can be accessed. The particular information required to identify the egress gateway and to specify the route may depend on the particular addressing scheme of the packet switched networks involved.

6. Identifying Unwanted Circuit Switched Segments

The gateway indication message may be generated by any one of the elements in the call path and then passed along to other elements in the call path. In an exemplary embodiment, the gateway indication message may be generated by an egress gateway in the call path and then passed through the backward signaling path to other elements in the call path. For example, as depicted in FIG. 2, the egress gateway 116 may generate a gateway indication message that is passed through the backward signaling path to the ingress gateway 114.

The gateway indication message may be sent by the egress gateway 116 or another element at various different times during the call. In one embodiment, the egress gateway 116 might be programmed to send a gateway indication message at specific trigger points within the call. For example, the egress gateway 116 might be programmed to send a gateway indication message in the first backward Call Control message indicating that the second telephone 102 has been reached. The first backward Call Control message might take a variety of different forms, such as a RINGING message (e.g., NAM in DPNSS, ALTERTING in H.225.0/Q.931/QSIG) or a PROGRESS message (e.g. NIM in DPNSS), depending on the particular protocols used to establish the call.

In another example, the egress gateway 116 might be programmed to send a gateway indication message when the call has undergone a change in routing, such as a transfer to a different endpoint. This can occur, for example, where a call is routed to an operator who then routes the call to another party. This can also occur, for example, when a party drops out of a conference call that then reverts to a two-party conversation. Changes in routing may occur based on a variety of other events as well.

Many signaling systems send a transfer update or other such details between the resulting endpoints when a change in routing occurs. These transfer updates may be used to trigger the egress gateway 116 to send a gateway indication message. While some system do not support transfer updates, the egress gateway 116 may optionally be programmed to recognize the interaction that occurs between elements in changing the call's routing, and in response to detecting this interaction the egress gateway 116 may send a gateway indication message. This may result in the egress gateway 116 embedding the gateway indication message in a FACILITY, CONNECT or some other type of message.

When an element receives the gateway indication message, it may perform an action based on the contents of the gateway indication message. For example, when the ingress gateway 114 receives the gateway indication message, it may then use information in the gateway indication message to communicate with the egress gateway 116 in order to determine whether one or more segments in the call path may be bypassed. The element may further pass the gateway indication message along to another element; however, some elements may first modify the gateway indication message before passing it along to the next element.

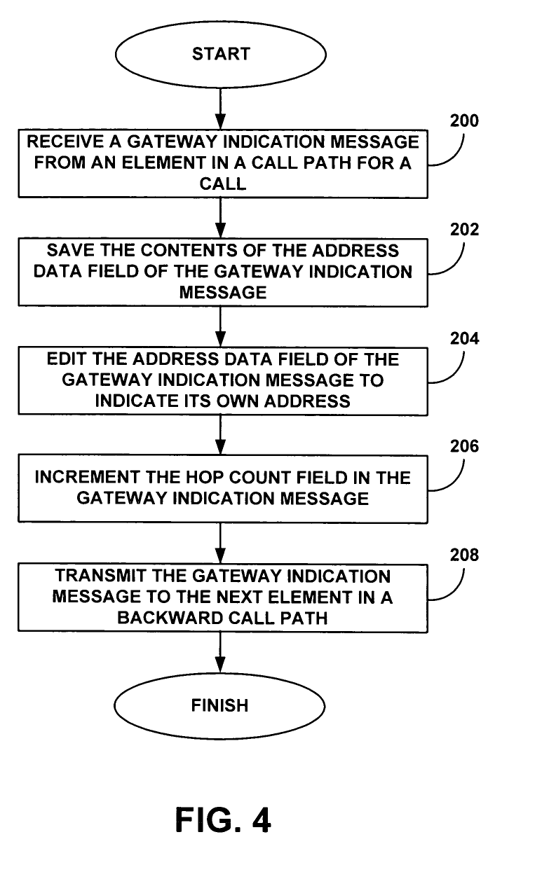

FIG. 4 is a flowchart of an exemplary process an egress gateway can use to handle a gateway indication message. At Step 200, the egress gateway designates itself a transit gateway for the call path. At Step 202, the egress gateway saves the contents of the address data field of the gateway indication message. At Step 204, the egress gateway edits the address data field of the gateway indication message to indicate its own address. At Step 206, the egress gateway increments the hop count field in the gateway indication message. At Step 208, the gateway transmits the gateway indication message to the next element in a backward call path.

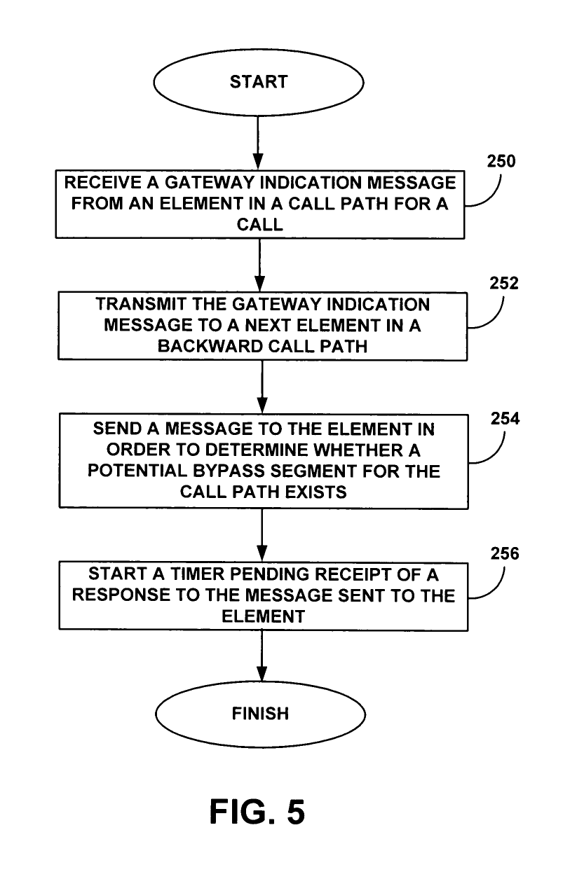

FIG. 5 is a flowchart of an exemplary process an ingress gateway can use to handle a gateway indication message. At Step 250, the ingress gateway receives a gateway indication message from an element in a call path for a call. At Step 252, the ingress gateway transmits the gateway indication message to a next element in a backward call path. At Step 254, the ingress gateway sends a message to the element in order to determine whether a potential bypass segment for the call path exists. At Step 256, the ingress gateway starts a timer pending receipt of a response to the message sent to the element. Thus, the ingress gateway uses the timer to determine whether it receives a response from the element within a predetermined amount of time.

In one embodiment, the ingress gateway 114 may send a Loop Avoidance ENQuiry (“LAENQ”) message to the address identified in the address data field of the gateway indication message. The LAENQ message may include a call reference and a hop count, and it may also include indications of the media negotiation protocol in use and whether it has already negotiated a media path.

Table 2 illustrates exemplary fields that may be included in an LAENQ message.

TABLE 2
Exemplary LAENQ Message Fields

| Field | Type | Range | Description |
|---|---|---|---|
| 1 Call reference | Number | 1 . . . 65535 | The Call Reference may be obtained from a GIM |
| | | | or LAACK message |
| 2 Hop Count | Number | 1 . . . 25 | The Hop Count may be obtained from the GIM |
| 3 Protocol | Enum | 0 = Univ | Identifies the media capabilities negotiation |
| | | 1 = H.245 | protocol naturally used between the ingress |
| | | 2 = SDP | gateway and its peer termination element. |
| | | . . . | |
| 4 Active | Boolean | | OPTIONAL. Present (TRUE) if the ingress |
| | | | gateway already knows the media capabilities of its |
| | | | peer packet switched network termination |

Upon receiving a LAENQ message, the egress gateway 116 or other element may register the address and hop count associated with the ingress gateway 114. The egress gateway 116 may respond with a Loop Avoidance ACKnowlege (“LAACK”) message. Thus, the gateways 114, 116 can use the LAENQ and LAACK messages to determine whether there is a viable packet based signaling path between them. Table 3 illustrates exemplary fields that may be included in an LAACK message.

TABLE 3
Exemplary LAACK Message Fields

| Field | Type | Range | Description |
|---|---|---|---|
| 1 Call reference | Number | 1 . . . 65535 | Relating to the associated telephony call (and as |
| | | | specified in the LAENQ), it may be implicit in the |
| | | | message signaling |
| 2 Protocol | Sequence of | | OPTIONAL. Present only if the media negotiation |
| preference | | | protocol proposed by the ingress gateway is not |
| | | | supported at the egress gateway. May be repeated |
| | | | for as many protocols as are supported by the |
| | | | egress gateway |
| 2.1 Protocol | Enum | 0 = Univ | |
| | | 1 = H.245 | |
| | | 2 = SDP | |
| | | . . . | |
| 2.2 Weighting | Number | 0.1 . . . 1 | 1 is highest, 0.1 is lowest preference |
| 3 New reference | Number | 1 . . . 65535 | OPTIONAL. Copied from the call reference in |
| | | | the GIM received by this gateway |
| 4 New Address | Server | | OPTIONAL. Copied from the call reference in |
| | Address | | the GIM received by this gateway |

If the egress gateway 116 is unable to exchange media control signaling in the protocol format identified in the LAENQ, the egress gateway 116 may include an indication of its own preferred protocol in the LAACK. The egress gateway 116 may further include an indication of whether it can support any alternative protocols, such as the universal loop avoidance media negotiation protocol. In the event that the egress gateway's preferred protocol is the same as that of the ingress gateway 114, then the subsequent media negotiations preferably use that protocol.

If the egress gateway 116 is a transit egress gateway, then it preferably also includes within the LAACK the call reference and address of the previous egress gateway. Upon receiving a LAACK that includes this new address, the ingress gateway 114 may send a LAENQ to the new address, and the ingress gateway 114 may restart its LAENQ response timer. As depicted in FIG. 2, the egress gateway 116 is not a transit egress gateway, and therefore would generally include its own address instead of an address of a previous aggress gateway.

The egress gateway 116 may receive more than one LAENQ message for the same call reference value. This can occur as successive ingress gateways respond to the gateway indication message as it progresses along the backward signaling path toward the calling party. Each LAENQ received by the egress gateway 116, however, may have a different hop count. A higher hop count generally indicates that the corresponding ingress gateway is further back in the call path, and a bypass path negotiated with that gateway may potentially bypass a greater number of segments than a bypass path negotiated with an ingress gateway having a lower corresponding hop count. Therefore, the egress gateway 116 may monitor the LAENQs it receives to determine which one has the highest hop count and thereby also determine which ingress gateway or other element corresponds to the highest hop count.

For each successive LAENQ the egress gateway 116 receives, it can check whether that LAENQ has a higher hop count than the LAENQ that the egress gateway 116 previously stored as having the highest hop count. If the hop count for the newly received LAENQ is the highest, then the egress gateway 116 may send a Loop Avoidance DISCard (“LADISC”) message to the ingress gateway corresponding to the LAENQ that was previously stored as having the highest hop count. The egress gateway 116 may then replace the details of the previously stored LAENQ with the details of the newly received LAENQ, and the egress gateway 116 send a LAACK response to the ingress gateway corresponding to the new LAENQ. If the hop count for the new LAENQ is lower than hop count for the previously stored LAENQ, then the egress gateway may respond by sending a LADISC message to the ingress gateway that sent new LAENQ.

Table 4 illustrates exemplary fields that may be included in a LADISC message.

TABLE 4
Exemplary LADISC Message Fields

| Field | Type | Range | Description |
|---|---|---|---|
| 1 Call reference | Number | 1 . . . 65535 | Relating to the associated |
| | | | telephony call (and as |
| | | | quoted in the LAENQ), |
| | | | it may be implicit in the |
| | | | message signaling |
| 2 Reason | Cause Code | | Selected from the list of |
| | | | cause codes below. |

Table 5 illustrates exemplary cause codes that may be used in an LADISC message. These codes can be used, for example, to specify a reason why the egress gateway 116 or other element is declining to attempt to form a bypass with the ingress gateway or other element. It should be understood, however, that these cause codes are merely exemplary in nature. Other cause codes might also be used, and other LADISC implementations may alternatively use a greater or fewer number of cause codes.

TABLE 5
Exemplary Cause Codes for LADISC Messages

| Name | Value | Description |
|---|---|---|
| Not Found | 404 | There is no call outstanding at this |
| | | gateway that corresponds |
| | | to the Call Reference that was sent. |
| Unsupported | 416 | Loop Avoidance server in LADISC |
| Media | | because it cannot find a suitable |
| Type | | Media Negotiation protocol |
| | | match from set offered by |
| | | the ingress gateway |
| Call/ | 481 | Similar to 404 |
| Transaction | | |
| Does | | |
| Not Exist | | |
| Request | 487 | Normal completion |
| Terminated | | |
| Decline | 603 | Server response to Ingress |
| | | Gateway's LAENQ when it |
| | | already has a better offer registered |

An ingress gateway that receives a LAACK with redirection to a further egress gateway might also successfully communicate with that egress gateway. If so, the ingress gateway might send a LADISC message to the previous egress gateway, and the LADISC message might include an indication that a more optimal route has been found. That egress gateway will then de-register the ingress gateway, and then ingress gateway may then be bypassed from the bearer path.

If the ingress gateway does not support any of the egress gateway's proposed protocols, then it may send a LADISC message with an indication that no connection is feasible because no common protocol is supported. However, if the ingress gateway adopts one of the egress gateway's protocols, then the ingress gateway may return a Loop Avoidance CONFirm (“LACONF”) message to the egress gateway, and any subsequent media negotiations may use the agreed protocol.

Table 6 illustrates exemplary fields that may be used in an LACONF message.

TABLE 6
Exemplary LACONF Message Fields

| Field | Type | Range | Description |
|---|---|---|---|
| 1 Call | Number | 1 . . . 65535 | Relating to the associated |
| reference | | | telephony call (and as |
| | | | quoted in the LAENQ), it may |
| | | | be implicit in the |
| | | | message signaling |
| 2 Protocol | Enum | 0 = Univ | OPTIONAL. Present if the egress |
| | | 1 = H.245 | gateway did not accept the media |
| | | 2 = SDP | negotiation protocol originally |
| | | . . . | proposed by this ingress gateway. |
| | | | Selected from the set provided |
| | | | by the egress gateway in its |
| | | | LAACK message. |
| 3 Active | Boolean | | OPTIONAL. Present (TRUE) |
| | | | if the ingress |
| | | | gateway already knows the |
| | | | media capabilities of its |
| | | | peer termination |

The ingress gateway 114 may optionally evaluate the time taken to receive an LAACK message in response to its LAENQ message. If the response time is within a predetermined amount of time, then the ingress gateway 114 may send a LACONF message to the egress gateway 116. If the response time is not within the predetermined amount of time, thereby potentially indicating that the route between the two gateways is not suitable for voice propagation, then the ingress gateway 114 may send a LADISC message to the egress gateway 116. The egress gateway 116 may optionally maintain a record of LAENQ messages rather than just storing information from the LAENQ message with the highest hop count. This may allow the egress gateway 116 to fall back to an alternate route if it determines that the route between itself and the ingress gateway corresponding to the highest hop count is for some reason unsuitable.

7. Negotiating an Alternate Call Path

If the egress gateway 116 does not receive any LAENQ messages, then it may determine that the call path includes no circuit switched network segments that may be bypassed and may then process the call accordingly. If the egress gateway 116 receives a LAENQ message and agrees with the ingress gateway 114 on a media negotiation protocol, then the egress gateway 116 may negotiate with the ingress gateway 114 on a new route for the call. The procedure for negotiating the new call path may vary depending on the present status of the call path.

When no path negotiation has yet started on any packet switched network segment associated with either of the gateways 114, 116, then the gateways 114, 116 may wait for the point to arrive in the call where such negotiation commences. If path negotiation has started on a segment associated with either of the gateways 114, 116, then the gateways 114, 116 may open the inter-gateway connection 130 between them. In one embodiment, the egress gateway 116 initiates the inter-gateway connection with the ingress gateway 114; however, in alternate embodiment an element other than the egress gateway 116 might initiate the inter-gateway connection 130.

Once a path has been established that includes segments associated with both gateways 114, 116, then their respective remote media capabilities may be exchanged. Each gateway 114, 116 may then attempt to negotiate a new call path, such as one that bypasses the circuit switched network segment 110, on behalf of the other gateway's endpoint. If a new path is successfully negotiated, then the call may be switched to use the new path. Segments that are no longer used after the new call path is in place may then be closed.

In negotiating a new call path via the inter-gateway connection 130, the gateways 114, 116 may use a variety of different protocols. These may be standardized protocols, but proprietary protocols might also be used. The inter-gateway connection 130 might be closed at any time be either gateway 114, 116. The gateway closing the inter-gateway connection 130 might provide the other gateway with an indication of the reason for closing the inter-gateway connection 130, and the reason may be used by the other gateway in determining how to process future renegotiations of the call path.

An egress gateway currently with a currently active inter-gateway connection with one ingress gateway might receive an LAENQ message from another ingress gateway. If the new LAENQ indicates a higher hop count, the egress gateway may acknowledge the new LAENQ and establish a new inter-gateway connection with the corresponding ingress gateway. The egress gateway may also close the original inter-gateway connection.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams. The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

I claim:

1. A method for maintaining quality of service for calls routed between a circuit switched network and a packet switched network, the method comprising:
determining that a call path for a call between a first device and a second device includes at least one segment over a circuit switched network and at least one segment over a packet switched network;
determining that the call path may be rerouted to bypass the at least one segment over the circuit switched network; and
rerouting the call path to bypass the segment over the circuit switched network.

2. A computer readable medium having stored therein instructions for causing a processor to execute the method of claim 1.

3. The method of claim 1, wherein the call path includes a first path for carrying bearer traffic and a second path for carrying signaling messages, and wherein rerouting the existing call path comprises rerouting the first path.

4. The method of claim 1, wherein determining that the call path may be rerouted to bypass the at least one segment over the circuit switched network comprises:
sending a message from a first element in the call path through a backward signaling channel for the call path, wherein the first element is located at a transition from the circuit switched network the packet switched network, and wherein the message indicates that the call path transitions from the circuit switched network to the packet switched network at the first element
receiving the message at a second element in the call path, wherein the second element is located at a transition from the packet switched network to the circuit switched network; and
thereafter negotiating between the first and second elements to determine if the call path can be rerouted to bypass the at least one segment over the circuit switched network.

5. The method of claim 4, wherein the message includes an call reference that identifies the call between the first second and the second device, a hop count for tracking a number of packet switched network segments encountered by the message on the backward signaling channel from the first element to the second element, and address data that identifies the first element.

6. The method of claim 4, wherein the first element is an egress gateway, and wherein the second element is an ingress gateway.

7. The method of claim 4, wherein the message is embedded within existing call control signaling messages for the call.

8. A method for bypassing circuit switched network segments in a call path for a call, the method comprising:
receiving a first message sent from a first element in the call path to a second element in the call path, wherein the message is sent via a backward signaling channel for the call, and wherein the message indicates that the call path transitions from a circuit switched network to a packet switched network at the first element;
transmitting the message to a next element along the backward signaling channel;
sending a second message to the first element in order to determine whether a connection can be formed with the first element in order to bypass a circuit switched network segment in the call path for the call; and
starting a timer to determine whether a response to the second message is received from the first element within a predetermined amount of time.

9. A computer readable medium having stored therein instructions for causing a processor to execute the method of claim 8.

10. The method of claim 8, wherein the first message includes a call reference that identifies the call, a hop count for tracking a number of packet switched network segments encountered by the first message on the backward signaling channel between the first element and the second element, and address data that identifies the first element.

11. The method of claim 8, wherein the second message includes a call reference that identifies the call, a hop count identifying a number of packet switched network segments between the first and second elements, and an identification of one or more media negotiation protocols supported by the second element.

12. The method of claim 8, further comprising:
receiving the response to the second message within the predetermined amount of time; and
negotiating with the first element to reroute the call path so as to bypass the circuit switched network segment in the call path for the call.

13. The method of claim 12, wherein the response identifies a media negotiation protocol supported by the first element, and wherein the media negotiation protocol is used in negotiating with the first element to reroute the call path.

14. The method of claim 8, further comprising:
receiving the response to the second message, wherein the response indicates a third element; and
sending a third message to the third element in order to determine whether a connection can be formed with the third element in order to bypass a circuit switched network segment in the call path for the call; and
starting a timer to determine whether a response to the third message is received from the third element within a predetermined amount of time.

15. The method of claim 14, further comprising:
receiving the response to the third message within the predetermined amount of time;
sending a message to the first element indicating that the second element is attempting to negotiate with an element other than the second element to reroute the call path so as to bypass the circuit switched network segment in the call path for the call; and
negotiating with the third element to reroute the call path so as to bypass the circuit switched network segment in the call path for the call.

16. The method of claim 8, wherein the second element is an ingress gateway.

17. A method for rerouting a call path for a call to bypass circuit switched network segments, the method comprising:
sending a message from a first element in a call path to a second element in the call path, wherein the message is sent via a backward signaling channel for the call, and wherein the message indicates that the call path transitions from a circuit switched network to a packet switched network at the first element;
receiving a response to the message from the second element; and
communicating with the second element to determine whether to reroute the call path in order to bypass a circuit switched network segment in the call path for the call.

18. A computer readable medium having stored therein instructions for causing a processor to execute the method of claim 17.

19. The method of claim 17, wherein the response wherein includes a call reference that identifies the call, a hop count identifying a number of packet switched network segments between the first element and the second element, and an identification of one or more media negotiation protocols supported by the second element.

20. The method of claim 17, wherein the message includes an identification of a first media negotiation protocol supported by the first element, wherein the second message includes an identification of a second media negotiation protocol supported by the second element, the method further comprising:
negotiating the between the first and second elements using the second media negotiation protocol in order to determine an alternate call path for the call that bypasses the circuit switched network segment; and
rerouting the call to use the alternate call path.

21. The method of claim 17, further comprising generating the message, wherein the message includes a call reference that identifies the call, a hop count for tracking a number of packet switched network segments encountered by the message on a backward signaling channel, and address data that identifies the first element.

22. The method of claim 17, further comprising:
receiving the message from a third element, wherein the message includes a call reference that identifies the call, a hop count for tracking a number of packet switched network segments encountered by the message on a backward signaling channel, address data that identifies the third element;
incrementing the hop count; and
altering the address data to identify first element.

23. The method of claim 17, wherein the first element is an egress gateway on an IP network, and wherein the second element is an ingress gateway on an IP network.

24. The method of claim 17, further comprising:
receiving responses to the message from multiple different elements in the call path, wherein the responses each includes a call reference that identifies the call, a hop count identifying a number of packet switched network segments between the first element and respective element that sent the response;
determining which response has a hop count that indicates the greatest number of packet switched network segments between the first element and the respective element that sent the response; and
negotiating with the respective element whose hop count indicated the greatest number of packet switched network segments in order to reroute the call to bypass the circuit switched network segment.
